(19) United States
(12) Patent Application Publication
(10) Pub. No.: US 2015/0175252 A1
(43) Pub. Date: Jun. 25, 2015

(54) Method For Producing A Central Wing Box

(71) Applicant: AIRBUS OPERATIONS SAS, Toulouse (FR)

(72) Inventors: Franck Batalla, Leguevin (FR); Denis Soula, Toulouse (FR); Javier Maqueda Lahoz, Toulouse (FR)

(73) Assignee: AIRBUS OPERATIONS SAS, Toulouse (FR)

(21) Appl. No.: 14/566,822

(22) Filed: Dec. 11, 2014

(30) Foreign Application Priority Data
Dec. 20, 2013 (FR) 13 63133

(51) Int. Cl. B64C 3/18; B23K 20/12

(52) U.S. Cl. CPC B64C 3/182; B23K 20/129

(57) ABSTRACT

A method for producing a central wing box including an upper panel, a lower panel, a front longeron, a rear longeron and four corners, wherein at least one panel and one longeron are obtained from a single flat metal wall which is bent along a bending line at approximately 90° which corresponds to a corner connecting said panel to said longeron.

### FIELD OF THE INVENTION

The present invention relates to a method for producing a central wing box.

### BACKGROUND OF THE INVENTION

As shown in FIG. 1, the structure of an aircraft comprises two subassemblies, on one hand a fuselage 10, and on the other hand a wing 12 which are connected via a box structure 14 called the central wing box.

As shown in FIG. 2, the central wing box 14 comprises on one hand two panels, an upper panel 16 and a lower panel 18, and on the other hand two longerons, a front longeron 20 and a rear longeron 22. As shown in FIG. 3, each panel or longeron comprises a skin 24 reinforced with stiffeners 26 secured to at least one of the faces of the skin 24. Generally, the stiffeners 26 are provided on the internal face of the skin.

For the remainder of the description, an internal surface or face corresponds to a surface or face which is oriented towards the interior of the central wing box. Conversely, an external surface or face corresponds to a surface or face which is oriented towards the exterior of the central wing box.

### BRIEF SUMMARY OF THE INVENTION

According to one variant embodiment, the central wing box is produced from metal elements made of aluminium alloy.

According to this variant, the skin and the stiffeners of the upper and lower panels 16, 18 or of the front longeron 20 are distinct and assembled by means of bolts. According to one production method, the stiffeners 26 are extruded, and then bolted to the panels.

In addition, the rear longeron 22 is obtained by machining a thick plate made of aluminium alloy so as to obtain the skin and the stiffeners in a single part.

According to this variant, the upper and lower panels and the front and rear longerons are produced separately then connected to each other, using angle bars, as shown in FIGS. 2 and 3, a first angle bar 28.1 between the upper panel 16 and the front longeron 20 and a second angle bar 28.2 between the lower panel 18 and the front longeron 20.

Thus, this assembly comprises six joins 29 (shown in FIG. 3) between the rear longeron 22 and the upper panel 16, between the upper panel 16 and the first angle bar 28.1, between the first angle bar 28.1 and the front longeron 20, between the front longeron 20 and the second angle bar 28.2, between the second angle bar 28.2 and the lower panel 18, between the lower panel 18 and the rear longeron 22.

Each join 29 requires a phase of positioning the two elements to be assembled, a pre-assembly phase, for example by pinning, a drilling/boring phase, a phase of cleaning up the chips and a phase of riveting several attachment rows, to be added to the assemblies required for attaching the stiffeners to the panels.

Given the number of parts to assemble, this variant gives rise to substantial costs and production time.

According to another aspect, if the central wing box is used as a reservoir, the joins 29 must be sealed. What is more, the risk of leaks is greater the more joins there are.

Thus, aspect of the present invention may remedy the drawbacks of the prior art.

To that end, an aspect of the invention relates to a method for producing a central wing box comprising an upper panel, a lower panel, a front longeron, a rear longeron and four corners, said upper and lower panels and said front and rear longerons being arranged so as to form a closed perimeter, characterized in that at least one panel and one longeron are obtained from a single flat metal wall which is bent along a bending line at approximately 90° which corresponds to a corner connecting said panel to said longeron.

This solution reduces the time and costs of assembly by eliminating bolted or riveted joins between the panel and the longeron. Moreover, it reduces the on-board mass by eliminating the bolts and the rivets and the angle bar connecting the panel and the longeron according to the prior art. Finally, it makes it possible to eliminate any risk of leaking since the wall is continuous between the panel and the longeron.

According to a first variant, the upper and lower panels and the front and rear longerons are obtained from a single flat metal wall which is bent along several bending lines, at approximately 90°, said wall comprising two edges which are mutually parallel and are connected by a join so as to obtain the closed perimeter.

Advantageously according to this variant, the wall is bent along four bending lines, at approximately 90°, which form the corners of the central wing box, and in that the join is remote from said corners.

The join is preferably arranged in the front longeron.

According to one embodiment, the join is equidistant from the upper front corner and from the lower front corner of the central wing box.

According to another variant, the upper and lower panels and the front longeron are obtained from a single flat metal wall which is bent along two bending lines, at approximately 90°, said wall comprising two mutually parallel edges, a first edge connected by a join to the upper edge of the rear longeron and a second edge connected by a join to the lower edge of the rear longeron.

Advantageously according to this variant, the rear longeron is produced by machining a plate so as to obtain the skin and the stiffeners in a single part.

For preference, the join or joins is or are obtained by friction welding.

According to one preferred embodiment, the plate is stiffened before being bent.

The invention also relates to a central wing box obtained from the method described above.

### BRIEF DESCRIPTION OF THE DRAWINGS

Other features and advantages will emerge from the following purely exemplary description of the invention, with reference to the appended drawings, in which:

FIG. 1 is a perspective view illustrating a central portion of an aircraft,

FIG. 2 is a perspective view of a central wing box according to the prior art,

FIG. 3 is a schematic section view of a central wing box according to the prior art,

FIG. 4 is a section through a central wing box showing a first variant of the invention,

FIG. 5 is a section through a central wing box showing a second variant of the invention,

FIG. 6 is a section through a central wing box showing a third variant of the invention,

FIGS. 7A to 7D are sections showing the various steps of a first variant embodiment of the invention,

FIG. 8 is a section of a step of another variant embodiment of the invention,

FIG. 9 is a section of a step of another variant embodiment of the invention,

FIG. 10 is a schematic representation of a bending machine.

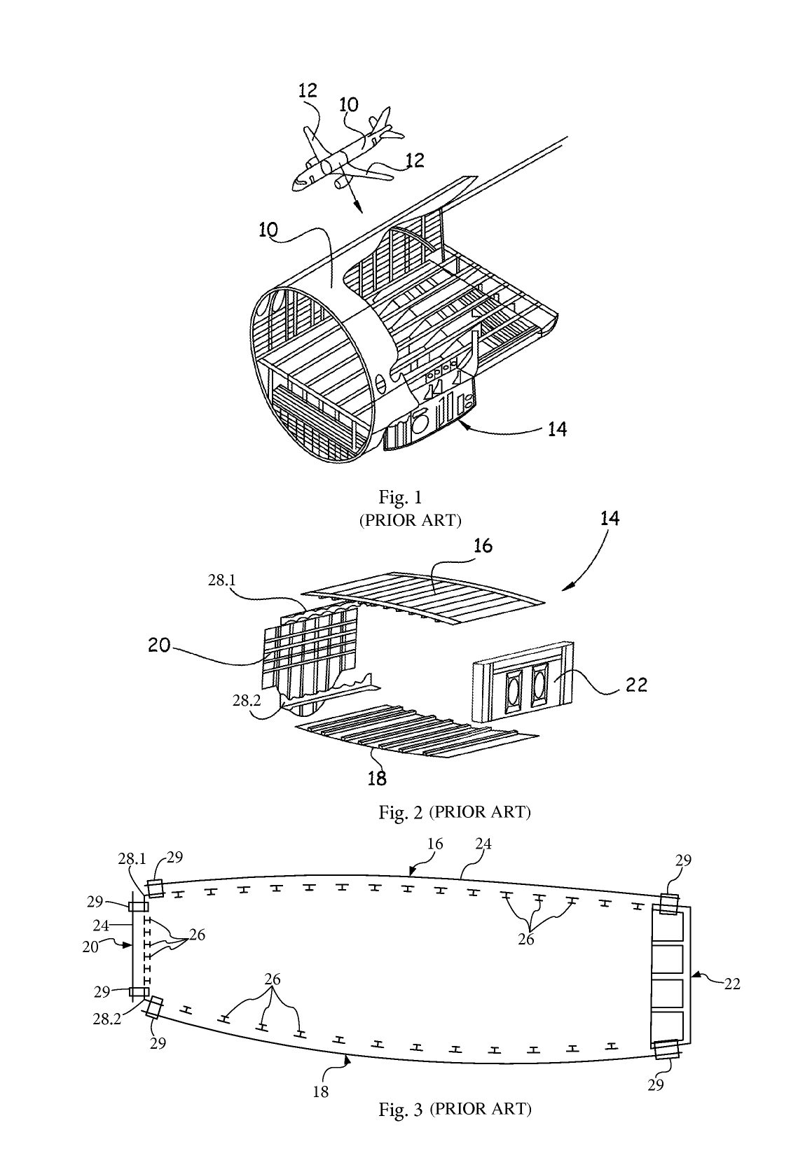

### DETAILED DESCRIPTION

For the remainder of the description, the longitudinal axis corresponds to that axis which extends from the front tip to the tail cone of the aircraft. A transverse plane corresponds to a plane perpendicular to the longitudinal axis. A transverse and horizontal direction is perpendicular to the longitudinal direction and parallel to the ground when the aircraft is on the ground.

A longitudinal and vertical plane corresponds to a plane containing the longitudinal direction and parallel to the vertical direction when the aircraft is on the ground.

An element is said to be a front element if it is closer to the front tip of the aircraft than another element said to be a rear element.

An element is said to be an upper element if it is further from the ground than another element said to be a lower element.

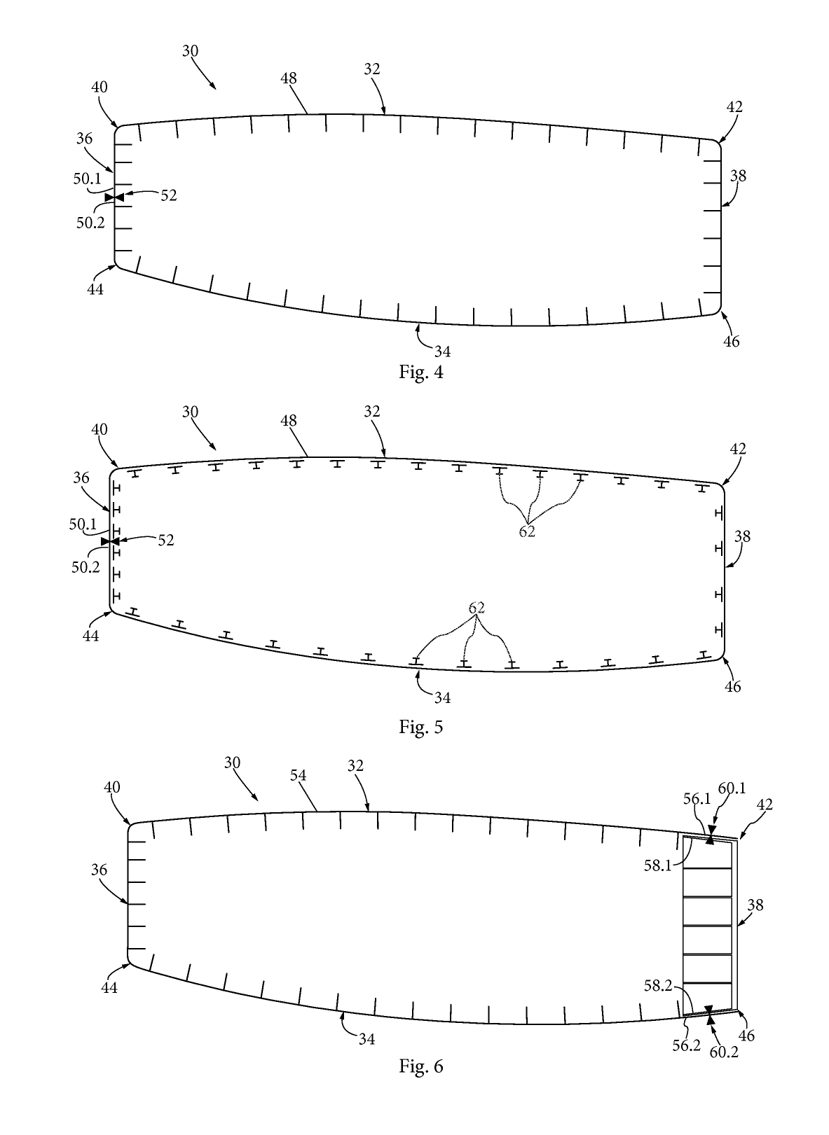

FIGS. 4 to 6 show a central wing box 30 comprising an upper panel 32, a lower panel 34, a front longeron 36 and a rear longeron 38. The longerons 36 and 38 are substantially planar and arranged approximately in spaced-apart transverse planes. The panels 32 and 34 are generally not planar but slightly convex.

The upper and lower panels 32, 34 and the front and rear longerons 36, 38 are arranged so as to form a closed perimeter in a longitudinal and vertical plane.

The central wing box comprises an upper front corner 40 which corresponds to the connection region between the upper panel 32 and the front longeron 36, an upper rear corner 42 which corresponds to the connection region between the upper panel 32 and the rear longeron 38, a lower front corner 44 which corresponds to the connection region between the lower panel 34 and the front longeron 36, a lower rear corner 46 which corresponds to the connection region between the lower panel 34 and the rear longeron 38.

All the corners 40 to 46 are parallel to the transverse and horizontal direction.

The panels and the longerons each comprise a skin with an internal face oriented towards the interior of the central wing box and an external face oriented towards the exterior.

The panels and the longerons each comprise stiffeners 62 on the internal face, parallel to the transverse and horizontal direction.

According to the invention, the panels 32, 34 and the longerons 36, 38 are made of metal.

Advantageously, the panels 32, 34 and the longerons 36, 38 are made of aluminium alloy. More particularly, the panels 32, 34 and the longerons 36, 38 are made of aluminium lithium alloy.

According to one feature of the invention, at least one panel and one longeron are obtained from a single flat metal wall which is bent along a bending line at approximately 90° which corresponds to the corner connecting said panel to said longeron. Thus, said wall forms the skin of said panel and of said longeron. This solution reduces the times and costs of assembly by eliminating the bolted joins between the panel and the longeron. Moreover, it reduces the on-board mass by eliminating the bolts and the angle bar connecting the panel to the longeron according to the prior art. Finally, it eliminates the risk of leaking since the wall is continuous between the panel and the longeron.

According to first and second variants shown in FIGS. 4, 5, 7C and 7D, all the panels 32, 34 and the longerons 36, 38 are obtained from a single flat metal wall 48 which is bent along several bending lines, at approximately 90° which correspond to the corners 40 to 46. This wall 48 forms the skins of the panels and of the longerons.

The wall 48 is approximately rectangular and comprises two mutually parallel edges 50.1 and 50.2. Once the central wing box has been produced, the edges 50.1 and 50.2 are parallel to the transverse and horizontal direction and are connected by a join 52.

For preference, the wall 48 is bent along four bending lines, at approximately 90°, which each correspond to a corner 40 to 46 and the join 52 between the edges 50.1 and 50.2 is remote from the corners 40 to 46. According to this configuration, the join 52 is subjected essentially to shear or tensile forces, which tends to improve the mechanical properties of the box.

According to one embodiment, the join 52 is arranged in the front longeron 36. The join 52 is equidistant from the upper front corner 40 and the lower front corner 44.

According to a first assembly method, the join 52 comprises at least one row of bolts or rivets.

Advantageously, the join 52 is obtained by welding, in particular by friction welding. This solution helps to reduce the on-board mass since it requires no bolts or rivets for assembling the panels and the longerons with each other.

According to a third variant shown in FIGS. 6 and 9, the upper and lower panels 32 and 34 and the front longeron 36 are obtained from a single flat metal wall 54 which is bent along two bending lines, at approximately 90°, which correspond to the upper front corner 40 and the lower front corner 44. This wall 54 forms the skins of the upper and lower panels 32 and 34 and of the front longeron 36.

The rear longeron 38 is produced in the same manner as in the prior art, by machining a thick plate of aluminium alloy so as to obtain the skin and the stiffeners in a single part.

According to this variant, the wall 54 has an approximately rectangular periphery and comprises two mutually parallel edges 56.1 and 56.2. The first edge 56.1 is connected to the upper edge 58.1 of the rear longeron 38 and the second edge 56.2 is connected to the lower edge 58.2 of the rear longeron 38.

The edges 56.1 and 56.2 are connected to the upper and lower edges of the rear longeron 38 by joins 60.1 and 60.2.

According to one assembly method, the joins 60.1 and 60.2 are obtained by at least one row of bolts or rivets.

According to one preferred assembly method, the joins 60.1 and 60.2 are obtained by welding, in particular by friction welding.

This third variant is preferred in cases where the thickness of the skin of the rear longeron 38 is different to those of the other panels 32, 34 and of the front longeron 36 and/or the height of the stiffeners of the rear longeron 38 is different to those of the stiffeners of the other panels 32, 34 and of the front longeron 36.

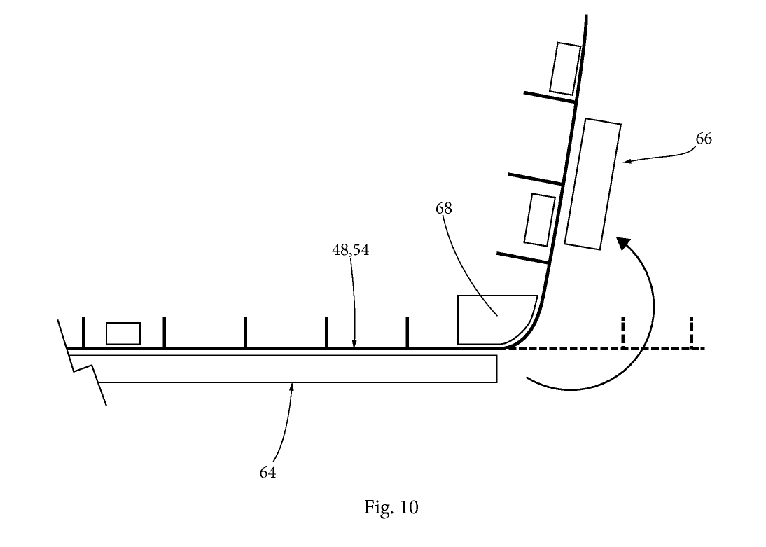

Whatever the variant, the wall 48 or 54 is bent using a large bending machine. As shown in FIG. 10, this machine comprises at least two parts, a first fixed part 64 which holds a first segment of the wall 48 or 54 on one side of the bending line and a second moving part 66 which pivots about a pivot axis which substantially coincides with the bending line and which drives the second segment of the wall or 54 on the other side of the bending line. A fixed profile 68 is provided at the bending line, said fixed profile having a radius of curvature which matches the desired radius of curvature on the central wing box.

Advantageously, the bending lines are produced one after another.

The corners obtained during the bending step have a radius of curvature which is suitable for the transmission of forces.

Advantageously, the walls 48 and 54 are stiffened before the bending step.

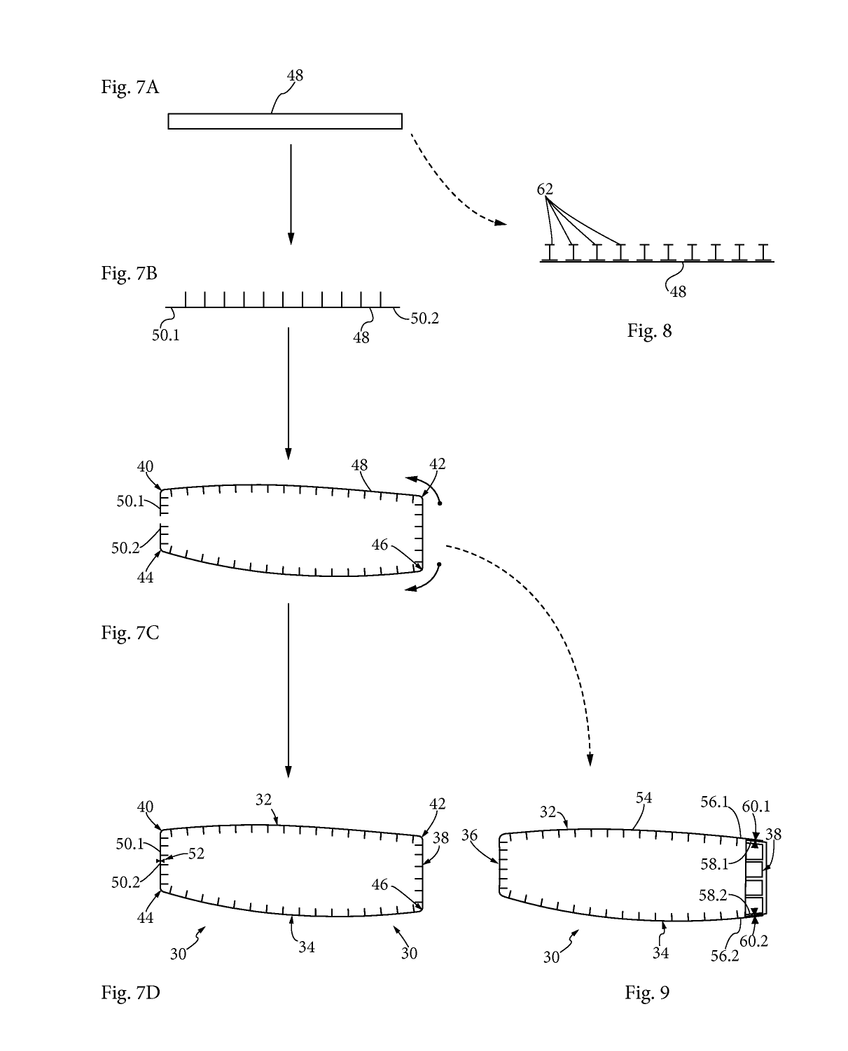

According to a first variant shown in FIGS. 4, 7A and 7B, the skin and the stiffeners of the panels and of the longeron or longerons are produced in one piece.

In this case, each wall 48 and 54 corresponds to a thick plate as shown in FIG. 7A in which the stiffeners are machined, as shown in FIG. 7B, before the bending step. “Thick” is to be understood as meaning that the thickness of the plate is at least equal to that of the skin plus the height of the tallest stiffener. “Height” is to be understood as meaning that dimension of the stiffener in a direction perpendicular to the skin of the panel or of the longeron.

Advantageously, according to this variant, the stiffeners and the skin are produced by high-speed machining.

According to this first variant, the curvatures of the upper and lower panels 32, 34 are obtained by means of a press.

According to a second variant shown in FIGS. 5 and 8, the stiffeners 62 are attached to the walls 48 and 54 using attachment elements such as bolts or rivets. In this case, the thickness of the skin is substantially equal to that of the skin of the panels and of the longeron or longerons. According to one embodiment, the stiffeners are extruded.

For preference, according to this second variant, the curvatures of the upper and lower panels 32, 34 are obtained before installation of the stiffeners 62, by roll forming.

According to this second variant, any changes in thickness are produced by machining prior to the profiling step.

The first variant makes it possible to reduce the on-board mass with respect to the second variant by eliminating the attachment elements attaching the stiffeners 62 to the wall 48 and 54.

1. A method for producing a central wing box comprising an upper panel, a lower panel, a front longeron, a rear longeron and four corners, the method comprising:
arranging said upper and lower panels and said front and rear longerons so as to form a closed perimeter, each upper or lower panel and each front or rear longeron comprising a skin and stiffeners; and
obtaining at least one panel and one longeron from a single flat metal wall bent along a bending line at approximately 90° corresponding to a corner connecting said panel to said longeron.

2. The method for producing a central wing box according to claim 1, wherein the upper and lower panels and the front and rear longerons are obtained from a single flat metal wall bent along several bending lines, at approximately 90°, said wall comprising first and second edges mutually parallel and connected by a join so as to obtain the closed perimeter.

3. The method for producing a central wing box according to claim 2,
wherein the wall is bent along four bending lines, at approximately 90°, which form the corners of the central wing box, and
wherein the join is remote from said corners.

4. The method for producing a central wing box according to claim 3, wherein the join is arranged in the front longeron.

5. The method for producing a central wing box according to claim 4, wherein the join is equidistant from the upper front corner and from the lower front corner of the central wing box.

6. The method for producing a central wing box according to claim 1, wherein the upper and lower panels and the front longeron are obtained from a single flat metal wall bent along two bending lines, at approximately 90°, said wall comprising first and second mutually parallel edges, the first edge connected by a join to the upper edge of the rear longeron and the second edge connected by a join to the lower edge of the rear longeron.

7. The method for producing a central wing box according to claim 6, wherein the rear longeron is produced by machining a plate so as to obtain the skin and the stiffeners in a single part.

8. The method for producing a central wing box according to claim 2, wherein the join or joins is or are obtained by friction welding.

9. The method for producing a central wing box according to claim 1, wherein the plate is stiffened before being bent.

10. A central wing box obtained from the method according to claim 1, said central wing box comprising:
an upper panel;
a lower panel;
a front longeron;
a rear longeron ; and
four corners,
wherein said upper and lower panels and said front and rear longerons are arranged so as to form a closed perimeter, each upper or lower panel and each front or rear longeron comprising a skin and stiffeners, and
wherein a metal wall bent along a bending line at approximately 90° forms at least one of the upper and lower panels and one of the front and rear longerons, said bending line corresponding to one of the four corner connecting said panel to said longeron.
